(19) United States
(12) Patent Application Publication
(10) Pub. No.: US 2008/0105489 A1
(43) Pub. Date: May 8, 2008

(54) ROOFMATES GABLEMASTER LADDER SUPPORT

(76) Inventor: Robert Garrett, Severn, MD (US)

Correspondence Address: ROBERT PLATT BELL;REGISTERED PATENT ATTORNEY, P.O. BOX 13165, Jekyll Island, GA, 31527, US

(21) Appl. No.: 11/972,377

(22) Filed: Jan. 10, 2008

Related U.S. Application Data
(63) Continuation of application No. 11/045,471, filed on Jan. 31, 2005.
Application No. 11/045,471 is a division of application No. 10/388,642, filed on Mar. 17, 2003, now Pat. No. 6,926,241.
Application No. 10/388,642 is a continuation-in-part of application No. 10/050,964, filed on Jan. 22, 2002, now Pat. No. 6,745,869.
(60) Provisional application No. 60/262,659, filed on Jan. 22, 2001.
(60) Provisional application No. 60/286,527, filed on Apr. 27, 2001.
(60) Provisional application No. 60/297,530, filed on Jun. 13, 2001.
(60) Provisional application No. 60/304,098, filed on Jul. 11, 2001.

(51) Int. Cl. E04G 3/26; E06C 7/48; E04D 15/00

(52) U.S. Cl. 182/45; 248/237

(57) ABSTRACT

A lightweight adjustable ladder and scaffold support is provided which may be marketed under the name GABLEMASTER™, a trademark of the inventor. A pair of rails are provided, spaced approximately 24 inches apart, the standard spacing of most roof joists. Connected to the rails through suitable holes and slots, are rods supporting an adjustable platform. One of the rods may be placed through a corresponding slot to achieve a suitable angle of adjustment corresponding to roof incline. The platform may be provided with a number of aluminum beams drilled with suitable holes, spaced apart and shaped so as to accept the leg of a standard extension ladder or siding jack. Bolts or pins may be passed through the holes to secure the ladder or jack to the platform. In addition, the platform may support a walking board, scaffold, or the like.

### CROSS-REFERENCE TO RELATED APPLICATIONS

The present application is a Continuation of U.S. patent application Ser. No. 11/045,471 (GARR-0015), filed on Jan. 31, 2005, and incorporated herein by reference; application Ser. No. 11/045,471 in turn is a DIVISIONAL of U.S. patent application Ser. No. 10/388,642, (GARR-0008) filed on Mar. 20, 2003 and incorporated herein by reference, which in turn is a Continuation-In-Part of U.S. patent application Ser. No. 10/050,964 (GARR-0005), filed on Nov. 18, 2003, both of which are incorporated herein by reference; Application Ser. No. 10,050,964 also claims priority from the following Provisional Patent Applications, all of which are incorporated herein by reference: Provisional U.S. Patent Application No. 60/262,650 (GARR-0001), filed on Jan. 22, 2001; Provisional U.S. Patent Application No. 60/286,527 (GARR-0002), filed on Apr. 27, 2001; Provisional U.S. Patent Application No. 60/297,530 (GARR-0003); and Provisional U.S. Patent Application No. 60/304,098 (GARR-0004), filed on Jul. 11, 2001.

### FIELD OF THE INVENTION

The present invention relates to the field of residential and commercial roofing. In particular, the present invention relates to a platform for supporting a ladder or pole jack for use in pitched roof construction.

### BACKGROUND OF THE INVENTION

Safety in pitched roof construction has been an ever-increasing concern. An alarming number of construction site accidents are due to falls from pitched roofs by workmen, particularly due to ladders or pump jack poles being improperly secured to pitched roofs.

A number of patents have been issued which describe various apparatus in the Prior Art for correcting the deficiencies noted above. However, most, if not all, of these attempts have failed in one or more ways, and none of these patented invention appear to have been commercially successful or readily available in the marketplace. Most of these schemes utilize unnecessarily complicated apparatus, which is too costly for the average roofer to afford, to heavy to lift to the jobsite, and to cumbersome to work with.

For example, Eisenmenger, U.S. Pat. No. 5,601,154, issued Feb. 11, 1997, discloses a portable suspended roof scaffold system. Eisenmenger uses a specialized apparatus (See FIGS. 1, 3, and 4) to secure a ladder to a roof. Once the ladder is secured, an adjustable platform (See FIG. 7) may be secured to the ladder to support a walkboard or the like. The problem with the Eisenmenger system is that it requires that a ladder with specialized fittings first be hauled up to the roof and secured before the platform can be installed.

Moreover, the ladder, once secured, covers a substantial portion of the roof being worked on. Since shingles are generally installed in horizontal rows, the ladder of Eisenmenger necessarily covers a portion of each row at all times (See, FIG. 20). The roofer must either move the entire apparatus or try to install shingles underneath the ladder. In addition, the apparatus, by requiring the use of a ladder, ties up one of the roofer's ladders at the jobsite. As a result, the roofer must purchase a separate ladder for such a purpose, or do without a ladder at another location on the site.

Bitner, U.S. Pat. No. 5,979,600, issued Nov. 9, 1999, discloses a leveling roof platform support. The Bitner device is an improvement over using a nailed-in 2″ by 4″ and much less complex than the Eisenmenger device. However, it appears that Bitner is limited to a device for supporting a walk-board or plank, and does not explicitly provide support for ladders, tools, supplies, or roofing materials. In addition, the Bitner device utilizes a fairly complex and expensive screw-jack leveling system to provide infinite adjustment of angle. While the screw-jack system may provide more levels of adjustment, it does so at the expense of added cost and complexity. Moreover, the screw-jack of Bitner does not appear to be sufficient to support large loads (e.g., square of shingles). No method of locking the screw jack into place appears to be present.

Thus, it remains a requirement in the art to provide a simple, flexible, lightweight, safe, and inexpensive system for supporting persons, ladders, roofing supplies, shingles, tools, and accessories on an inclined roof without covering up large portions of the roof with such a device.

In the roofing, siding, and construction arts, pump jacks are known in the art. A pair of pump jack poles may be placed on the ground and fixed to a structure. A scaffold-type walk board is attached to pump jacks, one at each pole, and the scaffold board assembly may be moved up and down the pump jack poles by means of pumping with the foot, for example. Such pump jack systems are well known in the art.

However, there are safety concerns with such systems. In particular, if the pump jack poles are not securely fastened to the ground or building, the entire assembly can tip over, causing injury or death to workers on the scaffold board or working below. In the Prior Art, workers merely place the pump jack poles on the ground without securing the poles in any way. Loose or compactable soil may allow the pump jack poles to sink or shift. Uneven or sloped terrain may cause the pump jack poles to move laterally. A means of securing pump jack poles remains a requirement in the art.

Mounting a ladder to an inclined roofing surface can be dangerous. If the ladder is not securely fastened to the roof, it may slide off, taking the user with it. Devices are known for holding a ladder on an inclined roof. For example, the so-called “J-hook” may be attached to a ladder and hooked over the peak of a roof to prevent the ladder from sliding off the roof. However, such a technique requires that the ladder be put onto the roof surface first, and slid all the way to the top. The roofer must either try to push the ladder up from the bottom, or climb to the peak using other means and then pull the ladder up.

For large roofs, or roofs with compound or unusual peak configurations, the J-hook may not be suitable for use. In addition, such ladders may need to be frequently moved or adjusted to allow work to progress, as they may get in the way of the work area. Thus, a need in the art exists for a ladder system for use on inclined roofs which does not require that the roofer first ascend the roof. In addition, a need exists in the art for a ladder system which may be flexible so as to allow a roofer to work on the roof surface without frequently relocating the ladder.

### SUMMARY OF THE INVENTION

In one embodiment, a lightweight adjustable ladder and scaffold support is provided which may be marketed under the name GABLEMASTER™, a trademark of the inventor. A pair of rails are provided, spaced approximately 24 inches apart, the standard spacing of most roof joists. Connected to the rails through suitable holes and slots, are rods supporting an adjustable platform. One of the rods may be placed through a corresponding slot to achieve a suitable angle of adjustment corresponding to roof incline.

The platform may be provided with a number of aluminum beams drilled with suitable holes, spaced apart and shaped so as to accept the leg of a standard extension ladder or siding jack. Bolts or pins may be passed through the holes to secure the ladder or jack to the platform. In addition, the platform may support a walking board, scaffold, or the like.

### BRIEF DESCRIPTION OF THE DRAWINGS

FIG. 1 is a perspective view of the ladder and scaffold support of the first embodiment of the present invention.

FIG. 2 is a side view of the ladder and scaffold support of the first embodiment of the present invention.

FIG. 3 is a top perspective view of the ladder and scaffold support of the first embodiment of the present invention.

FIG. 4 is another perspective view of the ladder and scaffold support of the first embodiment of the present invention, illustrating how a siding jack post may be attached.

FIG. 5 is another perspective view of the ladder and scaffold support of the first embodiment of the present invention, illustrating how a ladder may be attached.

FIG. 6 is a side view of the ladder and scaffold support of another embodiment of the present invention, illustrating how a ladder may be attached.

FIG. 7 is a perspective view of a modified version of FIGS. 1-6 with a movable jack post support.

FIG. 8 is a side view of a modified version of FIGS. 1-6 with a movable jack post support.

FIG. 9 is a top view of a modified version of FIGS. 1-6 with a movable jack post support.

FIG. 10 is a top view of a modified version of FIGS. 1-6 with a movable jack post support.

### DETAILED DESCRIPTION OF THE INVENTION

GABLEMASTER™ is an adjustable, lightweight, fully assembled aluminum platform which easily secures to roof truss layouts of two feet, 18 inches, and 16 inches (or other widths) on center and adjusts from 4/12 to 12/12 or other pitches. The GABLEMASTER™ eliminates makeshift devices or rental lifts because it easily installs on any pitched roof where extension ladders or pump jack poles are needed to set up scaffolding systems.

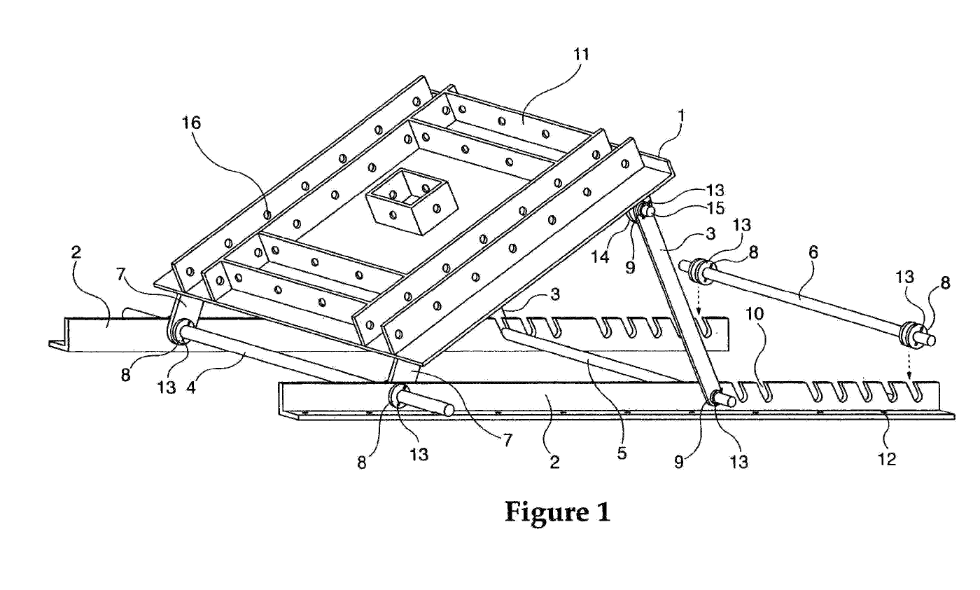

GABLEMASTER™ provides a level surface that secures ladders with adjustable steel bolts or pins. The product is ensured to provide safety for the user. The standard dimensions for this produce are 30″ in length and 54″ width, although other dimensional versions are permissible within the spirit and scope of the present invention. The GABLEMASTER™ invention will now be described in connection with FIGS. 1-10.

FIG. 1 is a perspective view of the ladder and scaffold support of the first embodiment of the present invention. Main support table 1 for the unit may support a ladder, siding jack, walking board, or the like and may be constructed from aluminum sheet of approximately ¼ inch in thickness. Support adjustment plates 11 may be provided from aluminum angle stock or flat plate welded to support table 1. In the alternative, support table 1 and adjustment plates 11 may be constructed from a single piece of cast aluminum.

Materials other than aluminum may be used, of course. However, for high strength and low weight, the inventor has found aluminum construction to work well. The apparatus of the present invention could be conceivably made of other metals (e.g., steel) or even from plastics or composites (e.g., fiberglass and/or carbon fiber construction) without departing from the spirit and scope of the present invention.

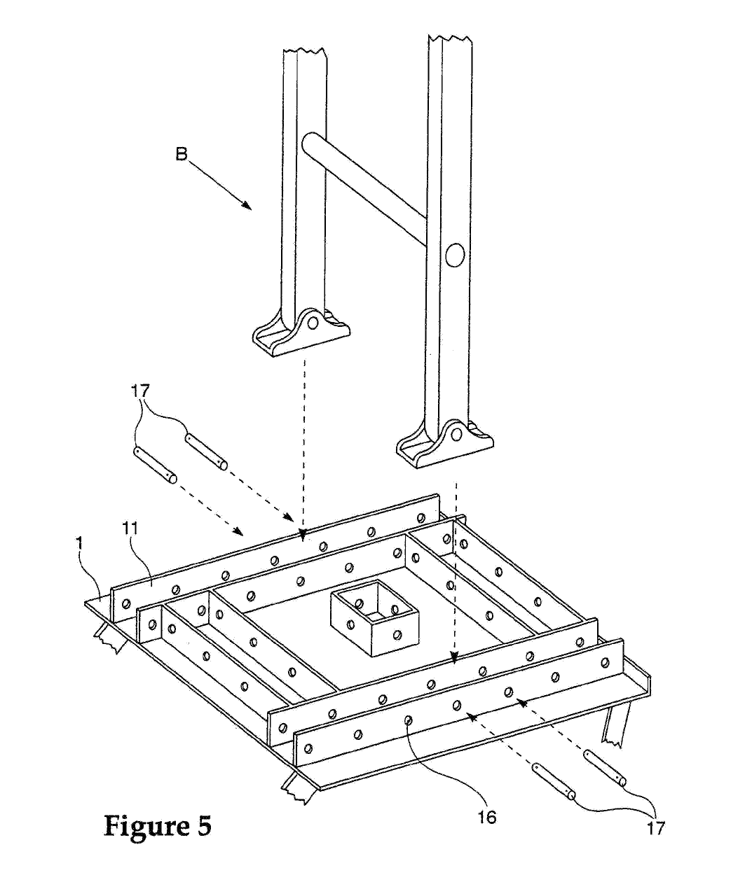

Pre-drilled holes 16 may be provided in support adjustment plates 11 at predetermined locations to secure a ladder leg, siding jack, or the like, as will be discussed below in connection with FIG. 5.

Main support bars 2 may be fabricated from aluminum channel and are designed to be fastened to a roof truss on 24″ centers. Although not illustrated here, an additional support bar 2 may be provided in a slidable fashion on connecting rods 4 and 5. Such an additional support bar or bars may be used to secure the device to roof trusses which are not on 24″ centers (e.g., 12″ or 16″ centers). Main support bars 2 may be secured to roof trusses by nailing or screwing through pre-drilled holes 12. If nails are used, double-headed nails are preferred, as they may be readily removed without damaging or marring the roof surface.

Typically, four to eight double-headed nails may be used to secure main support bars 2 to a roof truss. Eight or more pre-drilled nail holes may be provided in each of main support bars 2 in the preferred embodiment.

A plurality of grooves or notches 10 may be cut into support bars 2 to allow angle adjustment of main support table 1 to compensate for different roof pitches. Connecting rod 5 may be adjusted to a corresponding one of the notches 10 to provide correct support to main support table 1 via support bars 3. Support bars 3 may in turn be connected to main support table 1 via rod pin 15 and plate 14 in a pivoting fashion. Connecting rod 4 may rotate within the holes provided in main support bars 2 and rotatably support platform 1 via plates 7 to allow for rotation with angle adjustment.

Connecting rod 5 may be provided with spacers 9 and carter pins 13 to lock spacers 9 in place. Spacers 9 may provide proper alignment between connecting rod 5 and main support bars 2 to provide correct spacing for 24″ (or the like) roof truss centers. In an alternative embodiment, multiple spacers or spacer positions may be provided to allow the apparatus to adjust to different roof truss spacing.

An additional connecting rod may be provided as safety rod 6, also provided with carter pins 13 and spacers 8. Safety rod 6 may be used to attach a tether line or the like. Such a tether line may be used to allow workers to secure themselves or materials, tools, supplies, or the like, to the apparatus. If the worker falls from the roof, the tether line may help break or interrupt their fall.

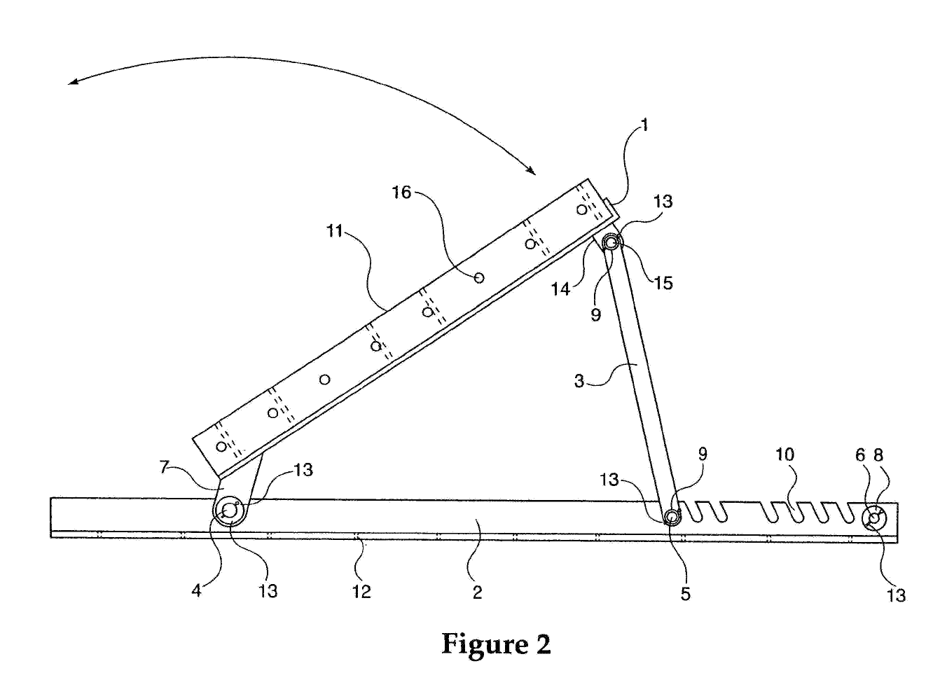

FIG. 2 is a side view of the ladder and scaffold support of the first embodiment of the present invention, illustrating how the angle of main support table 1 may be changed. The location and spacing of notches 10 is set to correspond to typical and popular roof pitches, and may allow adjustment from pitches from 4/12 to 12/12.

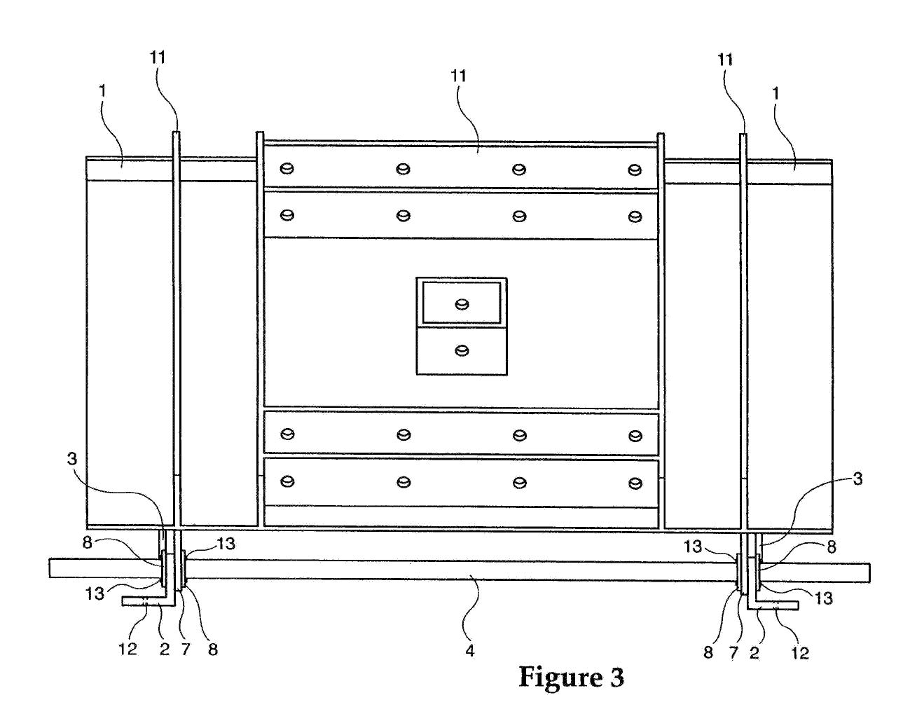

FIG. 3 is a top perspective view of the ladder and scaffold support of the first embodiment of the present invention, providing another illustration of the arrangement of support adjustment plates 11. It should be noted that the particular arrangement of support adjustment plates 11 is by way of example only. Other configurations may be provided without departing from the spirit and scope of the present invention.

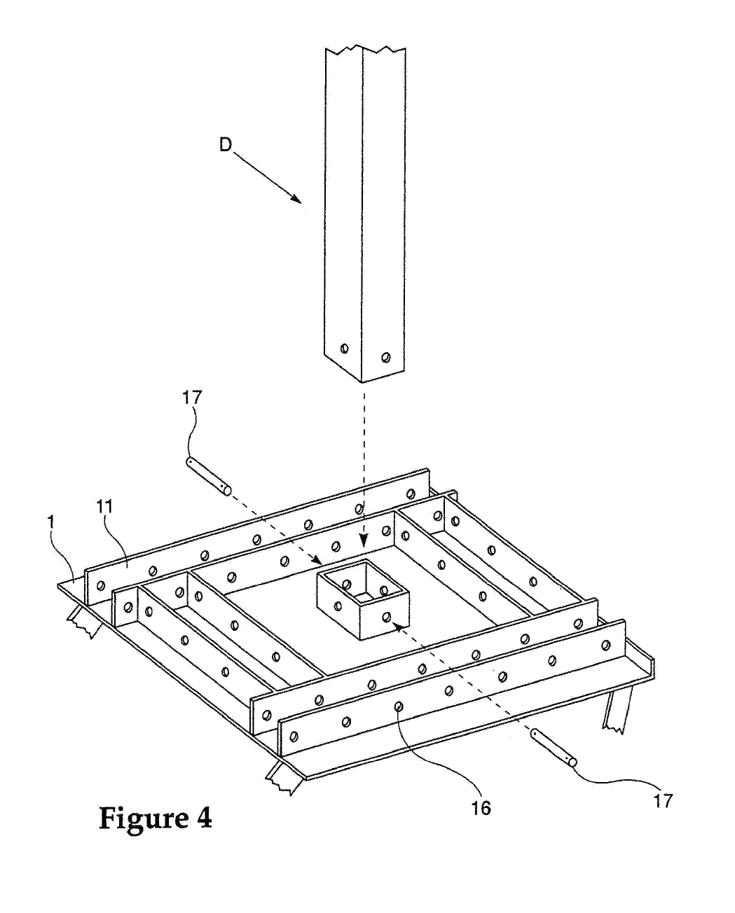

FIG. 4 is another perspective view of the ladder and scaffold support of the first embodiment of the present invention, illustrating how a siding jack post may be attached. Jack post d may comprise a portion of a scaffold assembly typically used in the industry for installing siding or the like. In some instances, it may be necessary to install siding or perform other siding work on a wall portion above an inclined roof section.

The present invention allows Prior Art scaffolding to be safely and easily installed above an inclined roof section. Other types of scaffolding and supports may also be supported by the present invention. As illustrated in FIG. 4, jack post D may be inserted between support adjustment plates 11 and secured with a pin or pins 17. The use of pins 17 and support adjustment plates 11 prevents ladder legs from slipping or other movement.

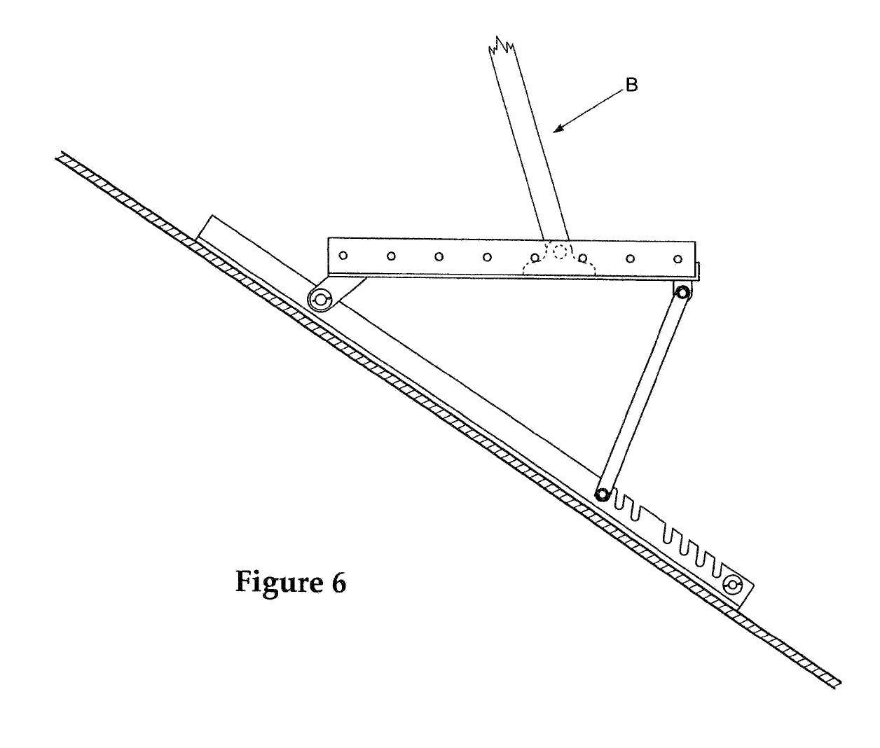

FIG. 5 is another perspective view of the ladder and scaffold support of the first embodiment of the present invention, illustrating how a ladder may be attached. FIG. 6 is a side view of the ladder and scaffold support of the first embodiment of the present invention, illustrating how a ladder may be attached. As illustrated in FIGS. 5 and 6, Legs of ladder B may rest between support adjustment plates 11. Support adjustment plates 11 may be spaced apart a standard distance of a typical aluminum, wood, or fiberglass construction ladder so as to readily accommodate such a ladder.

Lock pins 17 may be inserted into pre-drilled holes 16 to secure ladder B. As illustrated in FIG. 5, ladder B may be provided with feet (as is typical of such Prior Art ladders) which are locked into place between support adjustment plates 11 via lock pins 17. The use of lock pins 17 and support adjustment plates 11 prevents ladder B from slipping or other movement. Note that the ladder structure need not be modified by drilling or other changes which might void the ladder warranty or alter the structural characteristics of the ladder.

Legs of ladder B may rest between support adjustment plates 11. Support adjustment plates 11 may be spaced apart a standard distance of a typical aluminum, wood, or fiberglass construction ladder so as to readily accommodate such a ladder.

Other features may be added to the apparatus of the first embodiment of the present invention. For example, additional support adjustment plates 11 may be provided to secure a horizontal walkboard, scaffold, or the like to the apparatus.

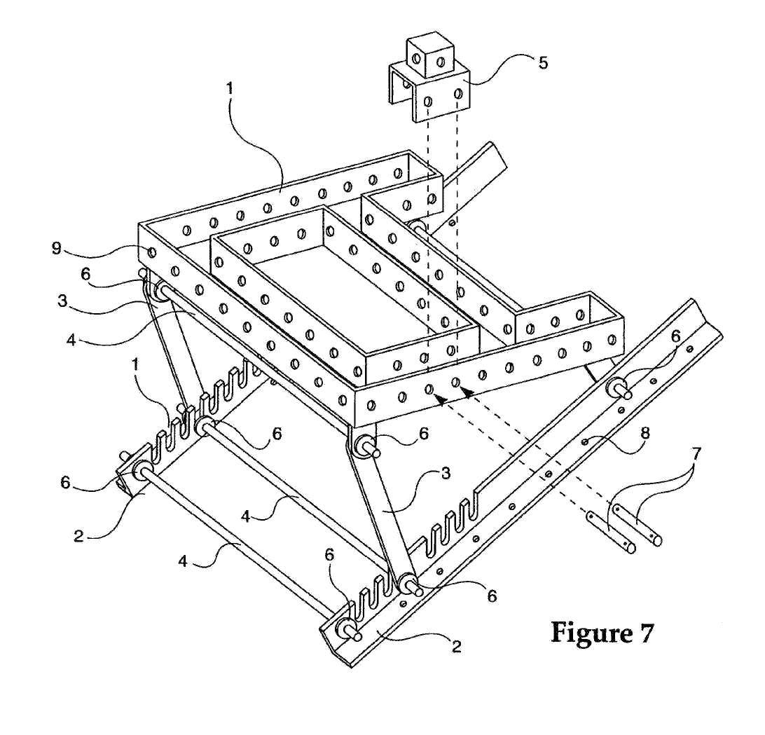

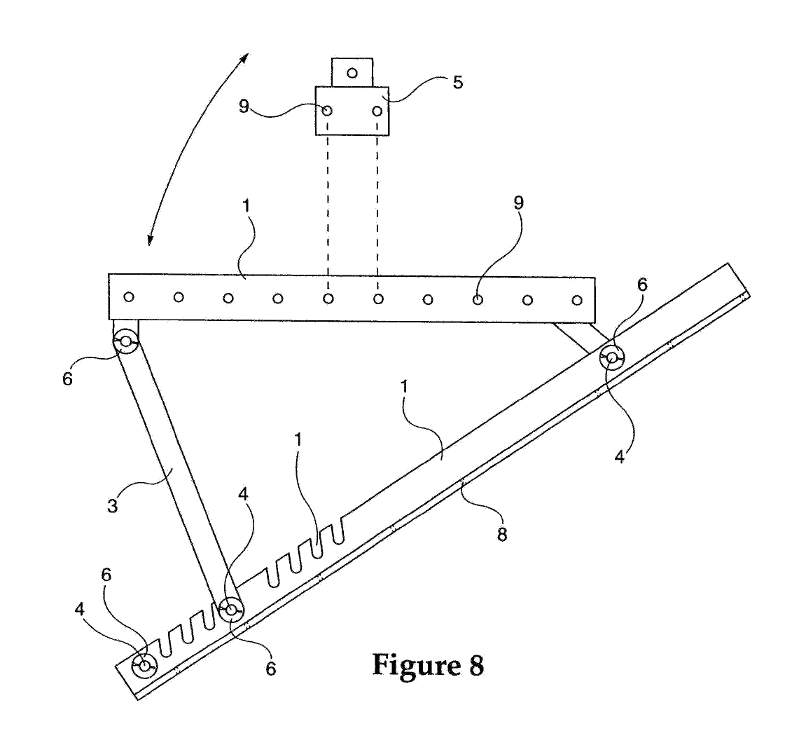

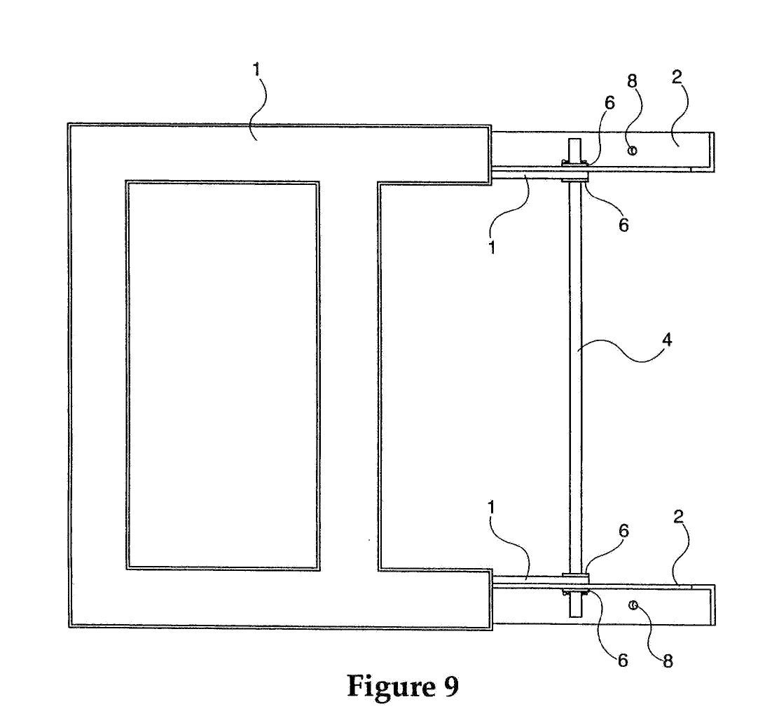

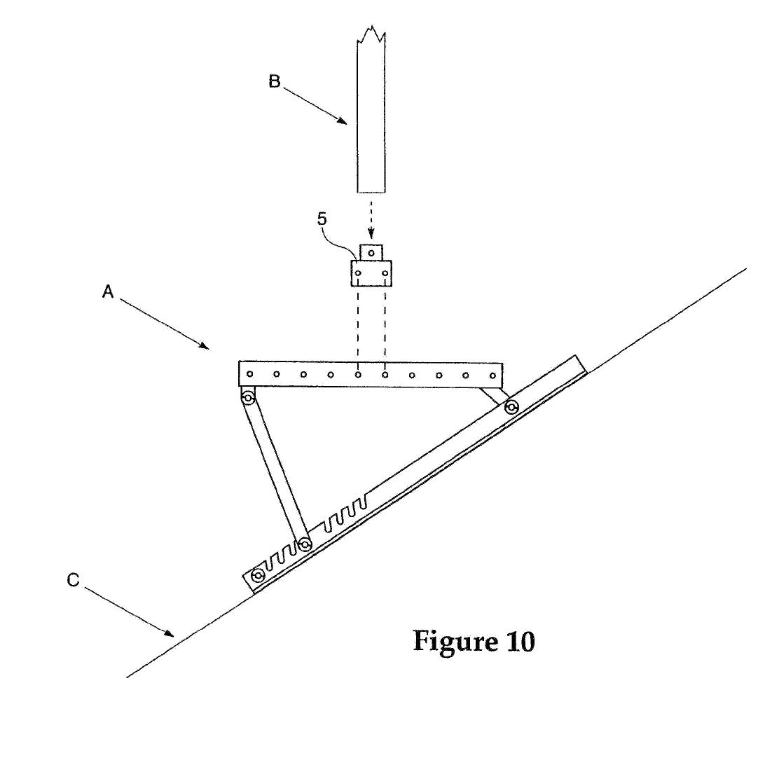

FIG. 7 is a perspective view of a modified version of FIGS. 1-6 with a movable jack post support. FIG. 8 is a side view of a modified version of FIGS. 1-6 with a movable jack post support. FIG. 9 is a top view of a modified version of FIGS. 1-6 with a movable jack post support. FIG. 10 is a top view of a modified version of FIGS. 1-6 with a movable jack post support.

In this modified version of FIGS. 7-10, a jack post mount 5 may be provided. Jack post mount 5 may be advantageously mounted to a number of positions within rails 1, secured by pins 7. Thus, the device need not be relocated if a jack post needs to be moved or positioned a few inches from the center portion of the platform (as in FIGS. 1-6).

It should be noted that the GABLEMASTER™ may also be used to support materials and supplies in addition to, or in when not being used as, a scaffold or ladder support. Squares of shingles, water coolers, tools, and other supplies may be placed upon the surface of the GABLEMASTER™ of FIGS. 1-10, which may be adjusted to prevent such materials from sliding off the roof.

While the preferred embodiment and various alternative embodiments of the invention have been disclosed and described in detail herein, it may be apparent to those skilled in the art that various changes in form and detail may be made therein without departing from the spirit and scope thereof.

I claim:

1. An apparatus for supporting at least one of ladders and pump jack poles on an inclined roof, comprising:
a pair of rails adapted to be spaced apart substantially by a predetermined standard spacing of roof joists;
a plurality of rods, connected to the rails through corresponding holes and slots;
an adjustable platform, connected to and supported by the plurality of rods; and
at least one bracket, mounted to the surface of the adjustable platform, the at least one bracket being provided with a plurality of holes and at least one pin for inserting into at least one of the plurality of holes to engage at least one of ladders and pump jack poles so as to secure the at least one of ladders and pump jack poles to the apparatus
wherein the pair of rails are adapted to be placed on a roof surface and secured with fasteners to roof joists beneath the roof surface,
wherein one of said plurality of rods is placed through a corresponding one of said slots adapted to achieve an angle of adjustment corresponding substantially to roof incline such that the adjustable platform is substantially horizontal.

2. The apparatus of claim 1, wherein the at least one bracket comprises two parallel pairs of brackets, the pairs spaced apart to accept legs of a ladder, each of the pair spaced apart from one another to accept an individual leg of a ladder between them, wherein when the at least one pin is inserted into the holes of the pairs of brackets, the at least one pin locks the legs of the ladder to the pairs of brackets.

3. The apparatus of claim 1, wherein the plurality of brackets comprises a square bracket to accept a pump jack pole, wherein when the at least one pin is inserted into the holes of the square bracket, the at least one pin locks the legs of the ladder to the pairs of brackets.
